(19) United States
(12) Patent Application Publication
(10) Pub. No.: US 2021/0017820 A1
(43) Pub. Date: Jan. 21, 2021

(54) LONG FLEXIBLE TUBING ELEMENT (VARIANTS)

(71) Applicant: UCT TECHNOLOGIES LIMITED LIABILITY COMPANY [RU/RU], Moscow (RU)

(72) Inventor: Rivener Musavirovich GABDULLIN, Moscow (RU)

(73) Assignee: UCT TECHNOLOGIES LIMITED LIABILITY COMPANY [RU/RU], Moscow (RU)

(21) Appl. No.: 17/042,923

(22) PCT Filed: Jul. 15, 2019
(86) PCT No.: PCT/RU2019/000504

§ 371 Date: Sep. 29, 2020

(30) Foreign Application Priority Data
Aug. 6, 2018 (RU) 2018128526

(51) Int. Cl. E21B 17/20; B29C 65/00; F16L 11/22

(52) U.S. Cl. CPC E21B 17/203; F16L 11/14; F16L 11/22; B29C 66/4322

(57) ABSTRACT

The invention relates to long-dimensional flexible tubes (coiled tubing). There are three variants of the basic channels (of an umbilical coiled tubing) proposed and all of them have two kind of the external flanges (edged or shaped ones) and include means of production. All variants include multi-stage sequential shaping process of one or multiple strips at an estimated geometry, and where isolated channels, partitions and flanges are formed during this process. If required, longitudinal butts of an additional longitude strips can be welded to them to form an umbilical coiled tubing which can be reeled up to a drum. Other types of service channels (electric, fiber-optic, capillary etc.) can be placed inside or outside channels in the form of a flexible belts. Flanges located beyond the outside dimensions of an umbilical coiled tubing may have a wave-type of form. Welding seams, flanges, centers of a closed channels and partitions are located, mainly, on the middle line of an umbilical coiled tubing's cross-section. The umbilical coiled tubing makes it possible to significantly increase possibilities of coiled tubing units in technological operations as well as in artificial lift methods due to its multi-channel design and, consequently, multifunctionality.

### FIELD OF THE INVENTION

The invention relates to long-dimensional flexible tubes (coiled tubing or flexible tubing), more specifically, reel spoolable coiled tubing.

### BACKGROUND

As practice of coiled tubing application in boreholes shows, it is reasonable to have multi-channel umbilical coiled tubing with various diameters, configurations, and auxiliary service channels for implementation of many technological operations inside boreholes as well as reservoir fluid lifting using different methods of artificial lift.

A multi-channel coiled tubing is known comprising several hydraulic and electrical channels, which are enclosed together in a single fused shell extruded from a polymer material with two flat surfaces for easy spooling. The extruded enclosure from polymeric material around the hydraulic and electrical channels forms a single multi-channel string in the shape of a long-dimensional flexible tape, which provides good protection for the hydraulic and electrical channels. Specific quantities and diameters of electric and hydraulic channels depend on whether electrical centrifugal submersible pump or hydraulic driven downhole pump is used. The hydraulic channels may comprise standard coiled tubing, plastic long-dimensional flexible pipes, or capillary tubes while electrical and information channels may comprise electrical wires or cables and fiber-optic lines (U.S. Pat. No. 8,459,965 issued Jun. 11, 2013).

One disadvantage of above-mentioned multi-channel umbilical coil tubing consists in increased weight of the multi-channel string due to deposited plastic. Another disadvantage is necessity to cut through the solid plastic enclosure in order to repair or replace a damaged electric line section (breakdown, earth fault, etc.) or fiber-optic or capillary line section (disrupted channel) followed by re-welding of plastic. In addition, deep and long scratches or abrasions on outer surface of plastic adversely affect the tightness of stripper and blowout preventer equipment.

A multi-channel coiled tubing is known comprising a set of service channels that matches to a desired well technology or artificial lifting method. This multi-channel coiled tubing string consists of two flexible long-dimensional service channels selected from the group comprising hydraulic lines, power electric cables, fiber-optic and electrically conductive information lines that are fused together with an elastic shell to form a long string section. The string consists of two long sections in elastic shells with selected sets of service channels. To interconnect sections, at least one mating surface is made on the elastic shell of each long section parallel to string axis, one of mating surfaces having elongated locking slots and the other one having mating elongated locking concavities that together ensure both connection of long sections into a multi-channel coiled tubing string during tripping in hole and disconnection during tripping out of hole (Patent RU No. 2644366 issued Feb. 09, 2018).

One disadvantage of above-mentioned multi-channel coil tubing consists in increased weight of the multi-channel string due to deposited plastic. In addition, deep and long scratches or abrasions on outer surface of plastic adversely affect the tightness of stripper and blowout preventer equipment.

A multi-channel umbilical ArmorPak long flexible tubing and method of its assembly by installing permanent weld clamps (dual banded) on contacts of standard flexible tubes (coil tubing) are known (www.cjstech.com). The multi-channel umbilical ArmorPak long coil tubing string is coiled off from the reel of coil tubing rig unit into a borehole to perform downhole operations or lifting of well fluid using, for example, submersible electric centrifugal pumps or hydraulic driven downhole pumps. If needed, additional standard flexible tubes (coil tubing) can be installed in the multi-channel umbilical long-dimensional ArmorPak flexible piping system either separately or inside desired channels.

Principal disadvantage of above mentioned configurable multi-channel umbilical flexible tubing is stepwise change in cross-section geometry of the string in the place of permanent weld clamps installation, which impairs integrity of the multi-channel umbilical coiled tubing system and its ability to pass through the stripper and blowout preventer. As a result, sealing ability of well equipment degrades and its service life decreases. The multi-channel umbilical flexible tubing also encounters technical difficulties in assembling a configuration with two or more service channels.

A multi-channel umbilical flexible tubing and method of its producing that includes placing one or few long-dimensional service channels, designed to deliver electrical energy, hydraulic energy, or fluids to a well and receiving borehole information on the surface, into a larger main coiled tubing, which is formed by wrapping a metal strip around the insulated service channel(s) and thereafter welding longitudinal edges of the metal strip (U.S. Pat. No. 8,925,627 issued Jan. 6, 2015) is also known and may be considered as the closest prior art.

Disadvantages of the aforementioned multi-channel umbilical flexible tubing are related with increased weight, rigidity and cost of the string due to placing all channels inside the main outer large diameter coil tubing, which has to bear all the weight of multi-channel string when being suspended on injector head, thereby causing the necessity to increase wall thickness of the coil tubing and use steels of higher grades. Besides, a difficulty arises with suspension and sealing of free internal channels of the string in the wellhead. If the metal strip is used with a welded internal support (brackets), the multi-channel string becomes more expensive due to complicated manufacturing process and significantly more rigid at spooling on a reel owing the internal supports occupying the radial positions.

### SUMMARY OF THE INVENTION

The first aim of present invention is to provide a coiled tubing string element, which can have various diameters, cross-sections, and/or configurations, in the form of several embodiments of basic isolated channel that can be produced from a single strip or several strips and has one or more flanges, the coiled tubing string element being intended for either independent application or assembling a long multi-channel coiled tubing string basic on the basic channel and comprising additional welded long-dimensional flexible parts.

The second aim of the present invention is to reduce tensile and compressive loads acting on the string tubing.

The aim of this invention is to produce, using a multi-stage shaping and welding, an element of coiled tubing string with reinforced flanges and weld seams, the weld seams, partition plates, and thickened mandrel subs (parts of the tubing) being arranged on the string cross-section midline to enable aligned spooling onto a standard reel.

According to one embodiment of the invention, the stated problem is solved, and the stated aim is achieved, by manufacturing a basic isolated channel, in an element of coiled tubing string comprising one basic isolated channel, from a single strip by shaping the strip from center to form walls of the basic isolated channel with remaining free outward ends of longitudinal edges and subsequent welding of these ends with each other along contacting (mating) surfaces to form an edge flange.

In another embodiment, edges of at least one of shaped strips are welded from different sides to the edge flange of basic isolated channel to form an additional outer isolated channel.

In another embodiment, the edge flange may extend beyond the outer string dimensions.

According to another embodiment of the invention, the stated problem is solved, and the stated aim is achieved by an element of coiled tubing string comprising one basic isolated channel, the basic isolated channel is manufactured from a single strip by shaping the strip from center to form a shaped flange in the form of longitudinal fold with welded interior, further shaping of another parts of the strip to form walls of the basic isolated channel with remaining free outward butts of longitudinal edges, and final welding of contacting surfaces to form the edge flange.

In another embodiment, the edges of two more arch-shaped strips are welded from different sides to shaped or edge flanges of the basic isolated channel to form two additional isolated channels.

Also, according to another embodiment of the invention, the isolated channel is formed from a single strip by shaping the strip from center to form a shaped flange, made in a form of a longitudinal fold with welded interior, followed by longitudinal shaping of other strip parts to form walls of the basic isolated channel and subsequent welding of contacts of the walls of the basic isolated channel with each other to form a jointing partition, followed by shaping of the remaining parts of the strip with subsequent welding of longitudinal edges from different sides to the shaped flange to form two outer isolated channels.

Also, according to another embodiment of the invention, the stated problem is solved, and the stated aim is achieved, by manufacturing basic isolated channel, in an element of coiled tubing string comprising one basic isolated channel, from two strips by separate shaping of each strip from center to form two arch-shaped strips with remaining free outward ends of longitudinal edges, subsequent welding along contacting surfaces to form two edge flanges of the basic isolated channel, the edge flanges being arranged diametrically opposite to each other.

In another embodiment, the edges of two arch-shaped strips are welded from different sides to the edge flanges of the basic isolated channel to form two additional isolated channels.

In another embodiment, one arch-shaped strip is made of steel with high tensile strength properties, and the second arch-shaped strip is made of steel with high plastic compressive strength properties, and wherein the umbilical flexible tubing is spooled onto a reel on a reel with a shaped part of the strip made of steel with high plastic compressive strength properties.

Also, according to another embodiment of the invention, the stated problem is solved, and the stated aim is achieved, by manufacturing a basic isolated channel, in an element of coiled tubing string comprising one basic isolated channel from a single strip by shaping the strip from center to form a shaped flange made in a form of a longitudinal fold with welded interior, followed by shaping of other strip parts to form walls of the basic channel with ends of longitudinal edges brought out to outside, followed by welding along contacting surfaces to form an edge flange, and wherein the edge or shaped flange of the basic isolated channel, which is located outside of outer dimensions of the umbilical flexible tubing, has a form of alternating convexities and concavities or has a wavy shape of alternating crests and troughs.

### BRIEF DESCRIPTION OF THE DRAWINGS

The present summary is illustrated by the cross-sectional and side view drawings of coiled tubing string elements. Welding operations are conducted along longitudinal lines of the strip, welding locations are indicated by bold arrows, the order of welding sequence is shown by bold Roman numerals, the welding seam on the cross-section is shown by a bold line.

FIG. 1 shows basic isolated channel made from a single strip with edge flange.

FIG. 2 shows element of two-channel coiled tubing string with isolated channels of the type “pipe in pipe” and flush edge flange.

FIG. 3 shows element of two-channel coiled tubing string with isolated channels of the type “pipe in pipe” and protrusive edge flange.

FIG. 4 shows element of three-channel coiled tubing string with isolated channels of the type “pipe in pipe” with protrusive edge flange.

FIG. 5 shows basic isolated channel made from a single strip with shaped and edge flanges.

FIG. 6 shows element of a long three-channel coiled tubing string consisting of a central basic elliptical isolated channel with two welded arc-shaped strips.

FIG. 7 shows the initial phase of manufacturing an element of long three-channel coiled tubing string consisting of a central basic isolated channel with two welded arc-shaped lamellae.

FIG. 8 shows the final phase of manufacturing an element of a long three-channel coiled tubing string consisting of a central basic cylindrical isolated channel with two welded arc-shaped lamellae.

FIG. 9 shows element of a long three-channel coiled tubing string consisting of a central basic elliptical isolated channel with service tape inside and two welded arc-shaped lamellae.

FIG. 10 shows basic isolated channel made from two strips with two edge flanges.

FIG. 11 shows element of a long three-channel coiled tubing string consisting of a central basic elliptical isolated channel with two welded arc-shaped strips.

FIG. 12 shows element of a long cylindrical three-channel coiled tubing string consisting of a central basic elliptical isolated channel with two welded arc-shaped lamellae.

FIGS. 13 and 14 show basic isolated channel made from a single strip with shaped and edge flanges, the edge flange having a spline geometry in the form of alternating crests and troughs.

FIGS. 15 and 16 show basic isolated channel made from a single strip with shaped and edge flanges, the shaped flange having a wavy geometry in the form of alternating concavities and convexities.

FIGS. 17 and 18 show basic isolated channel made from two strips with two edge flanges, the edge flanges having a spline geometry in the form of alternating crests and troughs.

FIGS. 19 and 20 show basic isolated channel made from two strips with two shaped flanges, the shaped flanges having a wavy shape in the form of alternating concavities and convexities.

### DETAILED DESCRIPTION OF THE INVENTION

An element of coiled tubing string consists of a single or several shaped and specially welded together strips to form a basic isolated channel with one or two outer flanges, the basic isolated channel may be applied either independently or as a part of lengthy coiled tubing produced using multiple successive stages of shaping, welding, and attaching additional shaped strips. Embodiments of the long coiled tubing string element, which can have various diameters, cross-sections, and/or configurations, and is basic on several types of a basic isolated channel that can be produced from a single strip or several strips and has one or more flanges, the coiled tubing string element being intended for either independent application or assembling a long multi-channel coiled tubing string basic on the basic channel, as well as methods of manufacturing thereof, are presented below.

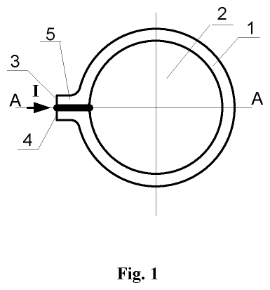

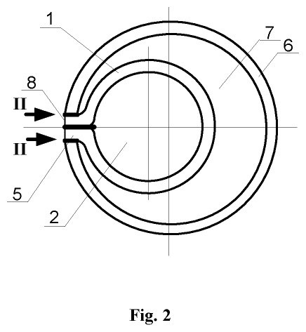

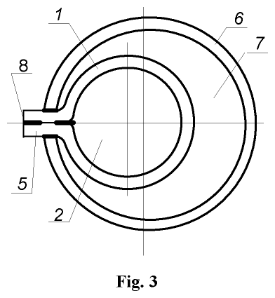

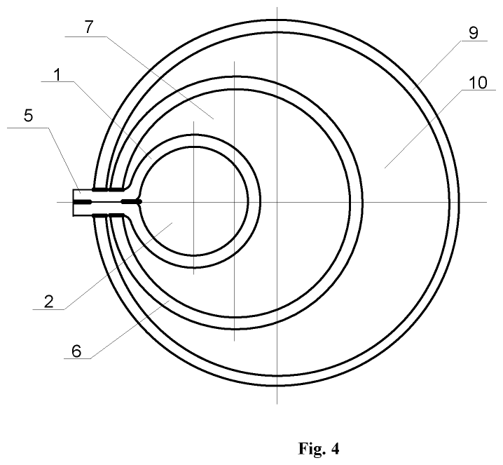

First embodiment of basic isolated channel 2 for the coiled tubing string element, as FIG. 1 shows, is manufactured by initial shaping strip 1 by series of rollers from its center to form wall of isolated channel 2 with arranging ends 3 and 4 of the inverted longitudinal edges of strip 1 on the same side and aligning them mirror-like along two planes faced one against another from both sides of the central plane A-A, and subsequent welding of contacting surfaces of the ends 3 and 4 of inverted longitudinal edges with each other to form the basic isolated channel 2 with edge flange 5. In the first sub-embodiment of the first embodiment (FIG. 2), a two-channel element of long coiled tubing string is manufactured by welding ends of the second shaped strip 6 to outer sides of edge flange 5. As a result of welding, a second isolated channel 7 is formed, while the basic isolated channel 2 becomes enclosed by the second isolated channel 7, which corresponds to the type “pipe in pipe”, the end 8 of the edge flange 5 being either flush with outer string surface (FIG. 2) or extending beyond its dimensions (FIG. 3). The second shaped strip 6 is wider than strip 1 and can be shaped in the form of circle or ellipse in cross-section. In the second sub-embodiment of the first embodiment (FIG. 4), a three-channel element of long coiled tubing string is manufactured by welding ends of the third shaped strip 9 to outer sides of edge flange 5, thereby forming a third isolated channel 10, so that the basic isolated channel 2 is located inside the second isolated channel 7, which in turn is located inside the third isolated channel 10.

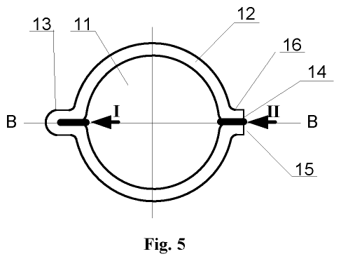

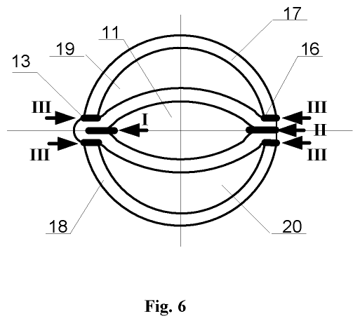

Second embodiment of basic isolated channel 11 for the coiled tubing string element, as FIG. 5 shows, is manufactured by initial shaping strip 12 by series of rollers from its center to form a shaped flange 13 in the form of longitudinal fold with welded interior. Then lateral parts of strip 12 are shaped with facing ends 14 and 15 of inverted longitudinal edges of strip 12 one against another from both sides of the central plane B-B, and subsequently welding the contacting surfaces of the ends 14 and 15 of inverted longitudinal edges with each other to form basic isolated channel 11 and edge flange 16. In the first sub-embodiment of the second embodiment (FIG. 6), edges of two arch-shaped strips 17 and 18 may be welded from different sides to shaped 13 and edge 16 flanges of the basic isolated channel 11, which may have cross-section in the form of ellipse or two connected arcs, to form two additional isolated channels 19 and 20, respectively.

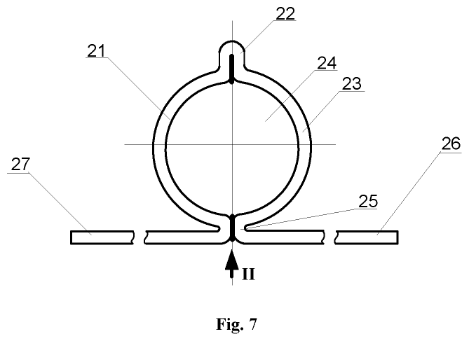

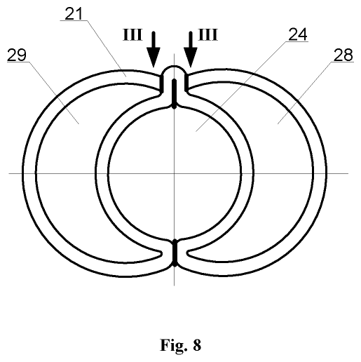

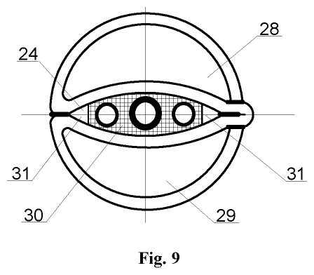

Third embodiment of basic channel of the coiled tubing string element, as FIG. 7 shows, is manufactured by initial shaping a single strip 21 from center to form shaped flange 22 in the form of longitudinal fold with welded interior, further longitudinal shaping of another parts of the strip 21 to form wall 23 of the basic isolated channel 24, subsequent welding of wall contactsof the basic isolated channel 24 to form a jointing partition 25, shaping of remaining lateral parts 26 and 27 of the strip 21, and final welding of longitudinal edges from different sides to the shaped flange 22 to form two outer isolated channels 28 and 29 around the basic channel 24 (FIG. 8). Owing to great rigidity of so produced multi-channel string, which requires application of reels with a large diameter, such strings can be used, for example, on offshore platforms. As a special case of third embodiment, the basic isolated channel 24 may have cross-section in the form of ellipse or two connected arcs and contain a service tape 30 with electrical, fiber-optical, and/or capillary lines inside, while the entire string has the shape of circle in cross-section (FIG. 9). The space 31 between inner wall of basic channel 24 and outer surface of service tape 30 can be used as additional way to deliver chemicals or oil for lubrication of friction parts of submersible equipment to the hole bottom.

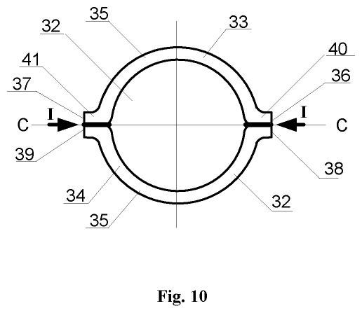

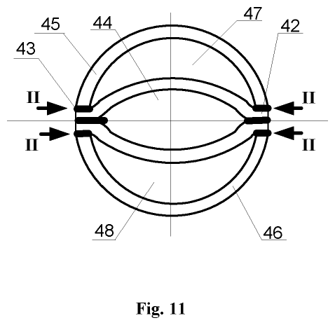

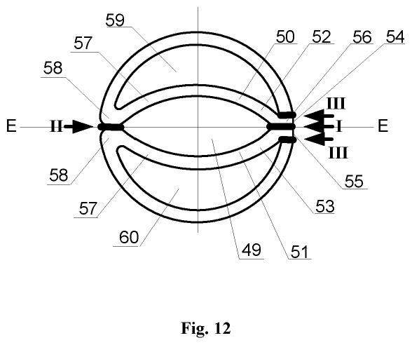

Fourth embodiment of basic channel 32 of coiled tubing string element, as FIG. 10 shows, is manufactured by initial shaping two separate strips 33 and 34 by series of rollers from their centers to form walls 35 of basic isolated channel 32 with arranging ends 36 and 37 of the inverted outwards longitudinal edges of strip 33 and ends 38 and 39 of the inverted outwards longitudinal edges of strip 34 on different sides and aligning them along two planes faced one against another from both sides of the central plane C-C, and subsequent welding of butt-contacted surfaces of ends 36 and 37 of inverted longitudinal edges of strip 33 and ends 38 and 39 of inverted longitudinal edges of strip 34 with each other to form the basic isolated channel 32 with two edge flanges 40 and 41. In above procedure, one arch-shaped strip 33 may be made of steel with high tensile strength, whereas the second arch-shaped strip 34 is made of steel with high compressive plasticity, the string being spooled onto reel with the shaped portion made of strip 34 with high compressive plasticity faced to the reel. In the first sub-embodiment of the fourth embodiment (FIG. 11), three-channel element of long coiled tubing string with the basic channel 32 is manufactured by welding edges of two arch-shaped strips 45 and 46 from different sides to edge flanges 42 and 43 of the basic isolated channel 44, which may have cross-section in the form of ellipse or two connected arcs, to form two additional isolated channels 47 and 48, respectively. In the second sub-embodiment of the fourth embodiment (FIG. 12), three-channel element of long coiled tubing string with central basic channel 49, which may have cross-section in the form of ellipse or two connected arcs, is manufactured by initial shaping two strips 50 and 51 by series of rollers to form walls 52 and 53 of basic isolated channel 49 with arranging ends 54 and 55 of the inverted longitudinal edges of strips 50 and 51 on the same side and aligning them along two planes faced one against another from both sides of the central plane E-E, subsequent welding of contacting surfaces of the ends 54 and 55 of inverted longitudinal edges with each other to form an edge flange 56 of two-strip semi-finished product 57, further shaping of the two-strip semi-finished product 57 to form walls 52 and 53 of basic isolated channel 49, subsequent welding of wall contacts of the basic isolated channel 49 to form a jointing partition 58, further shaping of remained lateral parts of strips 50 and 51 beyond the two-strip semi-finished product 57, and final welding of longitudinal edges of these lateral parts of strips 50 and 51 from different sides to the edge flange 56 to form two outer isolated channels 59 and 60 around the basic channel 49. In the multi-channel string, all arch-shaped strips located within one semicircle may be made of steel with high tensile strength, whereas the other arch-shaped strips located within another semicircle may be made of steel with high compressive plasticity, the string being spooled onto reel with the arch-shaped strips made of steel with high compressive plasticity faced to the reel.

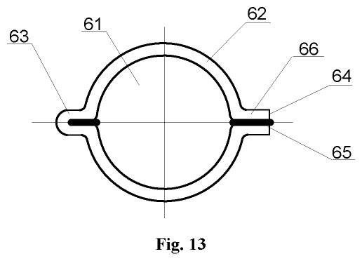

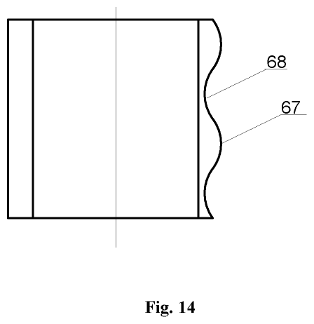

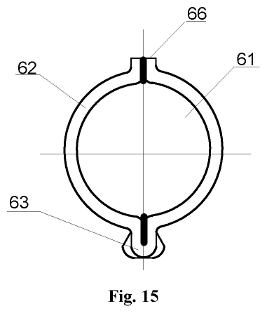

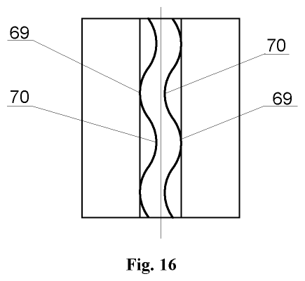

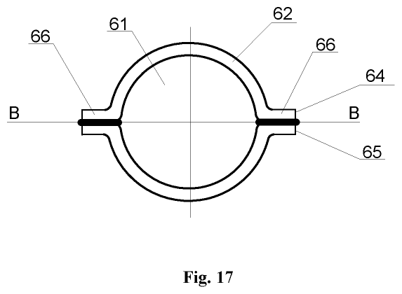

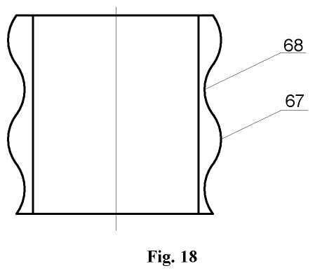

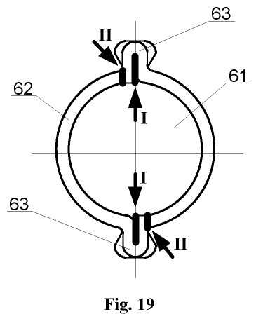

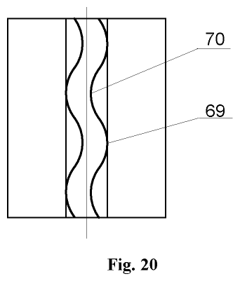

Fifth embodiment of coiled tubing string element with basic isolated channel having longitudinal load-carrying elements in the form of shaped and edge flanges located outside the outer string dimensions, as FIG. 13 shows, is manufactured, starting from the basic isolated channel 61, by initial shaping a single strip 62 from center to form a shaped flange 63 in the form of longitudinal fold with welded interior, further shaping of lateral parts of the strip 62 to form walls of the basic isolated channel 61 with remaining free outward ends of longitudinal edges 64 and 65, and final welding of contacting surfaces to form the edge flange 66, the edge flange 66 or shaped flange 63 of the basic isolated channel 61 located outside the outer string dimensions having a spline geometry in the form of alternating crests 67 and troughs 68 (FIG. 14) or wavy appearance at flange periphery with concavities 69 and convexities 70 (FIGS. 15 and 16). Two edge flanges 66 having a spline geometry in the form of alternating crests 67 and troughs 68 (FIGS. 17 and 18) or two shaped flanges 63 having wavy appearance at flange periphery with convexities 69 and concavities 70 (FIGS. 19 and 20) can be arranged diametrically opposite to each other. The main difference between crests, convexities and troughs, concavities are in the arrangement of the wave planes. The arrangement of convexities & concavities plane (wavy shape) is perpendicular to flange's plane. The arrangement of crests and troughs plane with spline geometry is parallel to flange's plane. In above-mentioned cases, entire string weight is transferred via load-carrying spline or wavy flanges to injector tracks (gripper blocks) having mating convexities and concavities or crests and troughs. The elevators with convexities and concavities or crests and troughs mating the concavities and convexities or troughs and crests on spline or wavy flanges can be applied as well. Availability of load-carrying spline or wavy flanges allows to significantly relieve walls of isolated channel from the string weight, which, in turn, allows to apply steels of less expensive grades in the element of long coiled tubing string or, alternatively, make thinner channel walls as well as repair multi-channel long coiled tubing strings by cutting out defective lengths and welding inserts or patches in the field conditions. In addition, availability of flanges allows to arrange weld seams, partition plates, and thickened flanges on the string cross-section section midline parallel to reel axis, which enables aligned spooling onto a standard reel. It should be noted that the availability of load-carrying spline or wavy flanges does not exclude the use of plane edge flanges 66 or shaped flanges 63 as frictional load-bearing elements for injector tracks (gripper blocks).

All above embodiments of multi-channel elements of long coiled tubing strings do not exclude all necessary processing procedures required to produce long flexible pipes (coiled tubing) such as edge machining, heating, sizing, etc. In addition, all proposed embodiments of coiled tubing string element can be applied in technological operations inside boreholes and in artificial lift methods.

All embodiments of multi-channel elements of umbilical coiled tubing strings are applicable as either conventional coil tubing or flexible lifting tubing with standard coiled tubing units but modified strippers, injector tracks (gripper blocks), guide archs, etc.

### INDUSTRIAL APPLICABILITY

The present invention makes it possible to significantly increase possibilities of coiled tubing units as well as the coiled tubing itself due to its multi-channel design and, consequently, multifunctionality.

1. An element of a lengthy umbilical flexible string, comprising a basic isolated channel, wherein the basic isolated channel is formed from a single strip by shaping the strip from center to form walls of the basic isolated channel with ends of longitudinal edges brought out to outside and subsequent welding the ends with each other along contacting surfaces to form an edge flange.

2. The element according to claim 1, wherein edges of at least one shaped strip are welded from different sides to the edge flange of the basic isolated channel to form an additional outer isolated channel.

3. The element according to claim 1, wherein the edge flange extends beyond outer dimensions of the lengthy umbilical flexible tubing.

4-10. (canceled)

11. The element according to claim 1, wherein during shaping the strip from center to form walls of the basic isolated channel a shaped flange made in a form of a longitudinal fold with welded interior is formed.

12. The element according to claim 1, wherein edges of two arch-shaped strips are welded from different sides to the shaped and edge flanges of the basic isolated channel to form two additional isolated channels.

13. The element according to claim 1, wherein the isolated channel is formed from a single strip by shaping the strip from center to form a shaped flange, made in a form of a longitudinal fold with welded interior, followed by longitudinal shaping of other strip parts to form walls of the basic isolated channel and subsequent welding of contacts of the walls of the basic isolated channel with each other to form a jointing partition, followed by shaping of the remaining parts of the strip with subsequent welding of longitudinal edges from different sides to the shaped flange to form two outer isolated channels.

14. An element of a lengthy umbilical flexible string, comprising a basic isolated channel, wherein the basic isolated channel is formed from two strips by separate shaping of each strip from center to form two arch-shaped strips with ends of longitudinal edges brought out to outside, followed by welding along contacting surfaces to form two edge flanges of the basic isolated channel, the edge flanges being arranged diametrically opposite to each other.

15. The element according to claim 14, wherein edges of two arch-shaped strips are welded from different sides to the edge flanges of the basic isolated channel to form two additional isolated channels.

16. The element according to claim 14, wherein one arch-shaped strip is made of steel with high tensile strength properties, and the second arch-shaped strip is made of steel with high plastic compressive strength properties, and wherein the umbilical flexible tubing is spooled onto a reel on a reel with a shaped part of the strip made of steel with high plastic compressive strength properties.

17. An element of a lengthy umbilical flexible string, comprising a basic isolated channel, wherein the basic isolated channel is formed from a single strip by shaping the strip from center to form a shaped flange made in a form of a longitudinal fold with welded interior, followed by shaping of other strip parts to form walls of the basic channel with ends of longitudinal edges brought out to outside, followed by welding along contacting surfaces to form an edge flange, and wherein the edge or shaped flange of the basic isolated channel, which is located outside of outer dimensions of the umbilical flexible tubing, has a form of alternating convexities and concavities or has a wavy shape of alternating crests and toughs.
